(19) United States
(12) Patent Application Publication
(10) Pub. No.: US 2013/0163825 A1
(43) Pub. Date: Jun. 27, 2013

(54) HEAD MOVEMENT DETECTION APPARATUS

(71) Applicant: DENSO CORPORATION, Kariya-city (JP)

(72) Inventor: Atsushi Shimura, Kariya-shi (JP)

(73) Assignee: DENSO CORPORATION, Kariya-city (JP)

(21) Appl. No.: 13/721,689

(22) Filed: Dec. 20, 2012

(30) Foreign Application Priority Data
Dec. 26, 2011 (JP) 2011-283892

(51) Int. Cl. G06K 9/00

(52) U.S. Cl. CPC G06K 9/00335
USPC 382/107

(57) ABSTRACT

A head movement detection apparatus capable of more reliably detecting a head movement of a subject. In the apparatus, an image capture unit captures a facial image of the subject. A trajectory acquisition unit acquires a trajectory of a facial feature point of the subject over time from a sequence of facial mages captured by the image capture unit. A storage unit stores a set of features of a trajectory of the facial feature point during a specific head movement made by the subject. A head movement detection unit detects the specific head movement made by the subject on the basis of a degree of correspondence between the set of features of the trajectory previously stored in the storage unit and a corresponding set of features of a trajectory acquired by the trajectory acquisition unit.

### CROSS-REFERENCE TO RELATED APPLICATION

This application is based on and claims the benefit of priority from earlier Japanese Patent Application No. 2011-283892 filed Dec. 26, 2011, the description of which is incorporated herein by reference.

### BACKGROUND

1. Technical Field

The present invention relates to a head movement detection apparatus for detecting a head movement of a subject.

2. Related Art

A known head movement detection apparatus, as disclosed in Japanese Patent No. 3627468, captures a facial image, i.e., an image including a face, of a subject repeatedly every predetermined time interval, and detects a head movement of the subject on the basis of a displacement from a position of a specific facial feature point appearing in a captured facial image to a position of the facial feature point appearing in a subsequent captured facial image.

The above disclosed apparatus compares the displacement of the facial feature point with a fixed threshold, and when it is determined that a predetermined relationship (inequality) therebetween is fulfilled, determines that a head movement has been made by the subject. The head movement, however, may change from person to person to a considerable degree. The fixed threshold may therefore lead to missing an actual head movement or to an incorrect determination that a head movement has been made by the subject in the absence of actual head movement.

In consideration of the foregoing, it would therefore be desirable to have a head movement detection apparatus capable of more reliably detecting a head movement of a subject.

### SUMMARY

In accordance with an exemplary embodiment of the present invention, there is provided a head movement detection apparatus including: an image capture unit that captures a facial image of a subject; a trajectory acquisition unit that acquires a trajectory of a facial feature point of the subject over time from a sequence of facial images captured by the image capture unit; a storage unit that stores a set of features of a trajectory of the facial feature point of the subject during a specific head movement made by the subject, the trajectory being acquired by the trajectory acquisition unit from a sequence of facial images captured by the image capture unit during the specific head movement made by the subject; and a head movement detection unit that detects the specific head movement made by the subject on the basis of a degree of correspondence between the set of features of the trajectory previously stored in the storage unit and a corresponding set of features of a trajectory acquired by the trajectory acquisition unit.

With this configuration, even though a head movement (e.g., a head nodding or shaking movement) may change from person to person, it can be determined more reliably whether or not the specific head movement has been made by the subject.

Preferably, when the specific head movement is a reciprocating head movement, the set of features of the trajectory of the facial feature point of the subject during the reciprocating head movement made by the subject are at least one of a vertical amplitude, a horizontal amplitude, and a duration of reciprocating movement of the trajectory.

This leads to a more reliable determination of whether or not the specific head movement has been made by the subject.

Preferably, when the apparatus is mounted in a vehicle and the subject is a driver of the vehicle, the apparatus further includes: a vibratory component estimation unit that estimates a vibratory component due to a vehicle's behavior included in a trajectory of the facial feature point of the driver acquired by the trajectory acquisition unit; and a vibratory component removal unit that subtracts the vibratory component estimated by the vibratory component estimation unit from the trajectory of the facial feature point of the driver acquired by the trajectory acquisition unit to acquire a noise-free trajectory of the facial feature point of the driver. In the apparatus, the head movement detection unit detects the specific head movement made by the driver on the basis of a degree of correspondence between the set of features of the trajectory previously stored in the storage unit and a corresponding set of features of the noise-free trajectory of the facial feature point of the driver acquired by the vibratory component removal unit.

This can reduce vibration effects caused by the vehicle' behavior, and leads to a more reliable determination of whether or not the specific head movement has been made by the driver.

### BRIEF DESCRIPTION OF THE DRAWINGS

In the accompanying drawings:

FIG. 1A shows a schematic block diagram of a head movement detection apparatus in accordance with one embodiment of the present invention;

FIG. 1B shows a schematic block diagram of a head movement detector of the head movement detection apparatus;

FIG. 1C shows a schematic block diagram of a head movement detector of a head movement detection apparatus in accordance with one modification to the embodiment;

FIG. 2 shows exemplary installation of the head movement detection apparatus in a vehicle's passenger compartment;

FIG. 3 shows a flowchart for a personal database creation process;

FIG. 4 shows a an exemplary facial image of a driver;

FIG. 5A shows a vertical component of a trajectory of a driver's eye acquired from facial images captured during a head nodding movement;

FIG. 5B shows a horizontal component of the trajectory of the driver's eye acquired from the facial images captured during the head nodding movement;

FIG. 5C shows a vertical component of a trajectory of the driver's eye acquired from facial images captured during a head shaking movement;

FIG. 5D shows a horizontal component of the trajectory of the driver's eye acquired from the facial images captured during the head shaking movement;

FIG. 6 shows a flowchart for a head movement detection process performed in the head movement detection apparatus;

FIG. 7A shows a trajectory (in the vertical direction) of the driver's eye over time, where the trajectory includes a vibratory component due to a vehicle's behavior and a component due to a head movement of the driver;

FIG. 7B shows the vibratory component due to the vehicle's behavior included in the trajectory of FIG. 7A;

FIG. 7C shows the component due to the head movement of the driver included in the trajectory of FIG. 7A; and

FIG. 8 shows an exemplary display image.

### DESCRIPTION OF SPECIFIC EMBODIMENTS

The present inventions will be described more fully hereinafter with reference to the accompanying drawings. Like numbers refer to like elements throughout.

1. Hardware Configuration

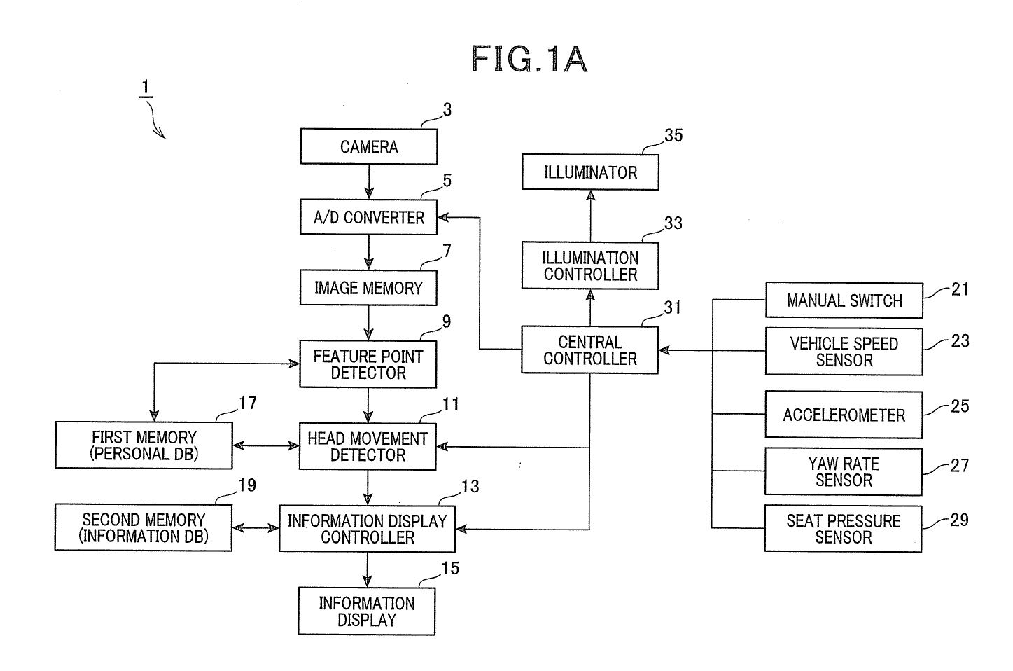

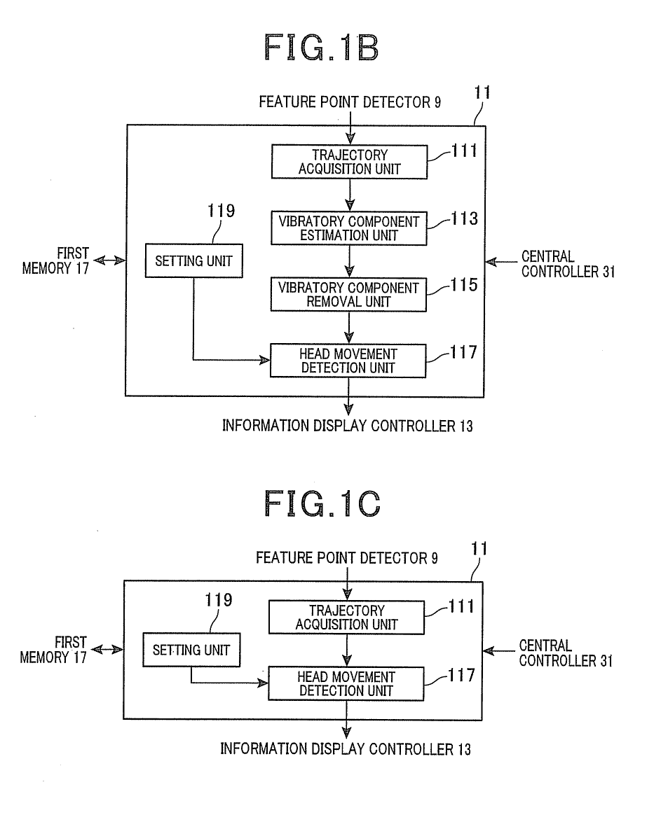

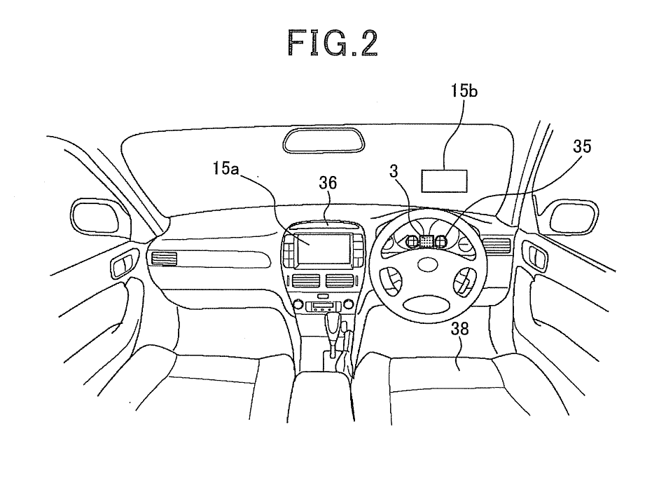

There will now be explained a head movement detection apparatus in accordance with one embodiment of the present invention with reference to FIGS. 1A, 1B, and 2. FIG. 1A shows a schematic block diagram of the head movement detection apparatus 1. FIG. 1B shows a schematic block diagram of a head movement detector of the head movement detection apparatus 1. FIG. 2 shows exemplary installation of the head movement detection apparatus 1 in a vehicle's passenger compartment.

The head movement detection apparatus 1 is mounted in a vehicle and includes a camera (as an image capture unit) 3, an A/D converter 5, an image memory 7, a feature point detector 9, a head movement detector 11, an information display controller 13, an information display 15, a first memory (as a storage unit) 17 for storing a personal database, a second memory 19 for storing an information database, a manual switch 21, a vehicle speed sensor 23, an accelerometer 25, a yaw rate sensor 27, a seat pressure sensor 29, a central controller 31, an illumination controller 33, and an illuminator 35.

As shown in FIG. 2, the camera 3 is disposed in the passenger compartment of the vehicle to capture an image including a face, i.e., a facial image, of a driver (as a subject). The A/D converter 5 analog-to-digital converts image data of the facial image captured by the camera 3 and stores the converted facial image data in the image memory 7. The feature point detector 9 detects a left or right eye (as a facial feature point) of the driver from the facial image data stored in the image memory 7 by using one of well-known image analysis techniques. The head movement detector 11 detects a head movement of the driver on the basis of a trajectory of the driver's eye detected by the feature point detector 9. The trajectory is a path connecting a sequence of locations of the driver's eye appearing in the respective facial images captured at predetermined time intervals. This head movement detection process will be described later in detail. The information display controller 13 controls the information display 15 in response to detections of the head movement detector 11. The information display 15 may display a reconstructed image, and may be a display 15a or a head-up display (HUD) 15b of the navigation system 36 or a combination thereof.

The memory 17 stores a personal database (which will be described later). The memory 17 stores a facial pattern, i.e., a pattern of facial feature points, of each user used for personal authentication (which will be described later). The memory 19 stores information (display images, such as icons) to be displayed on the information display 15.

The manual switch 21 can be manipulated by the driver. The vehicle speed sensor 23, the accelerometer 25, the yaw rate sensor 27, the seat pressure sensor 29 detect a speed of the vehicle, an acceleration of the vehicle, a yaw rate of the vehicle, a pressure applied to a driver's seat 38 by the driver, respectively. The central controller 31 performs various control processes in response to inputs provided to the manual switch 21 and detected values of the vehicle speed sensor 23, the accelerometer 25, the yaw rate sensor 27, and the seat pressure sensor 29. The illumination controller 33 controls the brightness of the illuminator 35. The illuminator 35 is disposed as shown in FIG. 2 to illuminate the driver's face.

Referring to FIG. 1B, the head movement detector 11 includes a trajectory acquisition unit (as trajectory acquisition means) 111, a vibratory component estimation unit (as vibratory component estimation means) 113, a vibratory component removal unit (as vibratory component removal means) 115, a head movement detection unit (as head movement detection means) 117, and a setting unit (as setting means) 119.

The trajectory acquisition unit 111 acquires a trajectory of the driver's eye (facial feature point) detected by the feature point detector 9 over time from a sequence of facial images captured at predetermined time intervals by using the camera 3. The trajectory is a path connecting a sequence of locations of the driver's eye in the respective facial images.

The vibratory component estimation unit 113 calculates or estimates a vibratory component due to a vehicle's behavior included in a trajectory of the driver's eye acquired by the trajectory acquisition unit 111.

The vibratory component removal unit 115 subtracts a vibratory component (which is noise) due to a vehicle's behavior estimated by the vibratory component estimation unit 113 from the trajectory acquired by the trajectory acquisition unit 111 to calculate a noise-free trajectory. That is, the noise-free trajectory is obtained by subtracting the vibratory component from the trajectory acquired by the trajectory acquisition unit 111.

The head movement detection unit 117 detects a specific head movement, such as a head nodding movement or a head shaking movement or the like, made by the driver (subject), on the basis of a degree of correspondence between a set of features (which will be described later) of the trajectory during the specific head movement made by the driver that are previously stored in the first memory 17 and a corresponding set of features of the noise-free trajectory calculated by the vibratory component removal unit 115. When the set of features of the noise-free trajectory are within a range of trajectory features (which will also be described later) specific to the driver (which means there exists a higher degree of correspondence between the set of features of the trajectory of the driver's eye during the specific head movement that are previously stored in the first memory 17 and the set of features of the noise-free trajectory), then the head movement detection unit 117 determines that the specific head movement has been made by the driver.

The setting unit 119 defines the range of trajectory features specific to the driver for detecting the specific head movement made by the driver as a function of the set of features of the trajectory of the facial feature point during the specific head movement made by the driver that are previously stored in the first memory 17.

2. Processes Performed in Head Movement Detection Apparatus

(1) Personal Database Creation

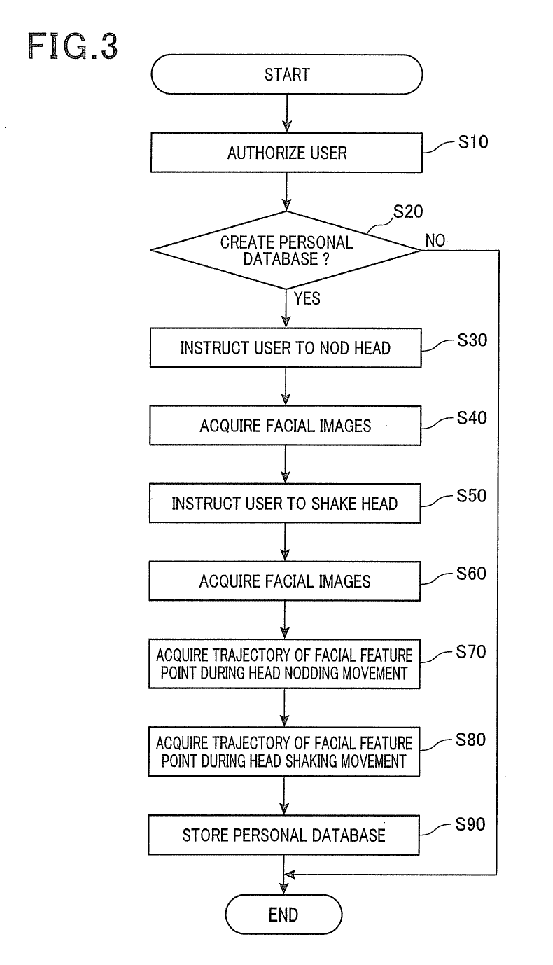

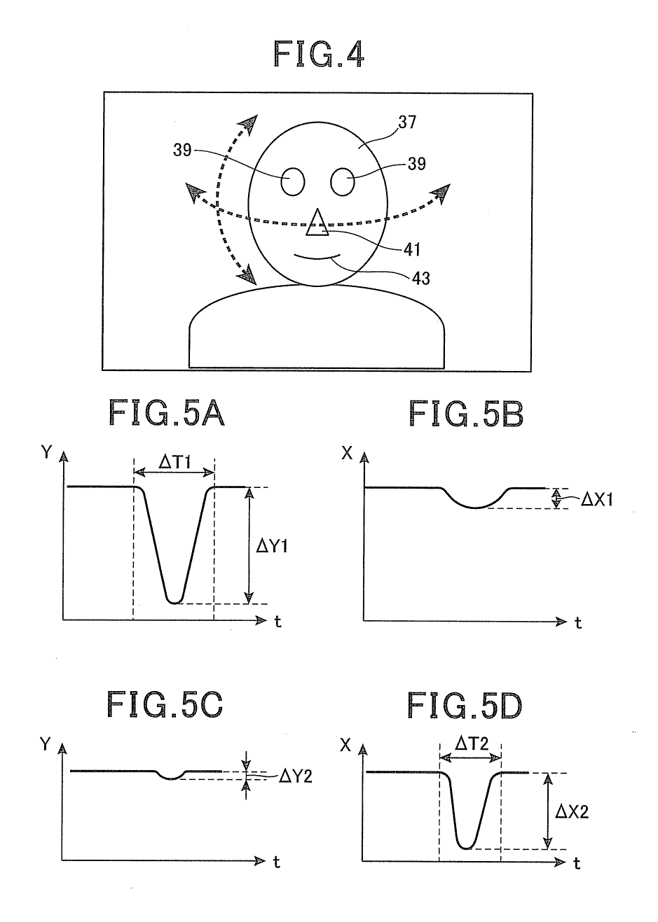

A personal database creation process will now be explained with reference to FIGS. 3, 4, and 5A-5D. FIG. 3 shows a flowchart for the personal database creation process performed in the head movement detection apparatus 1. FIG. 4 shows an exemplary facial image of the driver used for explaining the personal database creation process. FIGS. 5A and 5B show vertical and horizontal components of the trajectory of the driver's eye over time, respectively, acquired from facial images captured during a head nodding movement. FIGS. 5C and 5D show vertical and horizontal components of the trajectory of the driver's eye over time, respectively, acquired from facial images captured during a head shaking movement.

The personal database creation process is performed under control of the central controller 31 when the vehicle is stationary and the engine is stopped. Once a predetermined input is provided to the manual switch 21 by the driver or once the driver is sensed by the seat pressure sensor 29 or the camera 3 or the like, the personal database creation process is started.

Referring to FIG. 3, in step S10, a facial image of the driver is captured by the camera 3. The facial image of the driver, as shown in FIG. 4, includes a face 37 of the driver. Subsequently, a pattern of facial feature points (eyes 39, a nose 41, a mouth 43 and the like) is acquired from the captured facial image of the driver by the feature point detector 9. The acquired feature point pattern is compared with a feature point pattern of each user previously stored in the memory (personal database) 17. One of the previously stored feature point patterns that matches the acquired feature point pattern is selected. The driver can be identified with the user having the selected feature point pattern.

In step S20, a message such as “Would you like to create a personal database?” is displayed on the display 15a. If an input corresponding to the response “YES” is provided to the manual switch 21 within a predetermined time period after displaying the above message in step S20, then the process proceeds to step S30. If an input corresponding to the response “NO” or no input is provided to the manual switch 21 within the predetermined time period after displaying the above message in step S20, then the process is ended.

In step S30, a message such as “Please nod your head.” is displayed on the display 15a.

In step S40, a facial image of the driver is captured repeatedly every first predetermined time interval by using the camera 3 over a first predetermined time period after displaying the above message in step S30. The first predetermined time interval is set short enough to enable image analysis of a trajectory of the driver's eye over the first predetermined time period (which will be described later).

In step S50, a message such as “Please shake your heath” is displayed on the display 15a.

In step S60, a facial image of the driver is captured repeatedly every second predetermined time interval by using the camera 3 over a second predetermined time period after displaying the message in step S50. Each second predetermined time interval is set short enough to enable image analysis of a trajectory of the driver's eye over the second predetermined time period (which will be described later).

The first and second time intervals may be equal to each other or may be different from each other. The first and second time periods may be equal to each other or may be different from each other.

In step S70, the trajectory of the driver's eye over the first predetermined time period, which is a path connecting a sequence of locations of the driver's eye appearing in the respective facial images captured in step S40, is acquired. FIGS. 5A and 5B show vertical and horizontal components of the trajectory of the driver's eye during the head nodding movement, respectively. The vertical axis in FIG. 5A represents vertical positions, and the horizontal axis in FIG. 5A represents time. The vertical axis in FIG. 5B represents horizontal positions, and the horizontal axis in FIG. 5B represents time.

As shown in FIG. 5A, the vertical position (in Y-direction) of the driver's eye reciprocates with a large amplitude over time t. As shown in FIG. 5B, the horizontal position (in X-direction) of the driver's eye reciprocates with a small amplitude over time t. In step S70, in addition to the trajectory of the driver's eye over time, a vertical amplitude ΔY1, a horizontal amplitude ΔX1, and a duration of vertical reciprocating movement ΔT1 of the trajectory are acquired.

In step S80, the trajectory of the driver's eye over the second predetermined time period, which is a path connecting a sequence of locations of the driver's eye appearing in the respective facial images captured in step S60, is acquired. FIGS. 5C and 5D show vertical and horizontal components of the trajectory of the driver's eye during the head shaking movement, respectively. The vertical axis in FIG. 5C represents vertical positions, and the horizontal axis in FIG. 5C represents time. The vertical axis in FIG. 5D represents horizontal positions, and the horizontal axis in FIG. 5D represents time.

As shown in FIG. 5D, the horizontal position (in X-direction) of the driver's eye reciprocates with a large amplitude over time t. As shown in FIG. 5C, the vertical position (in Y-direction) of the driver's eye reciprocates with a small amplitude over time t. In step S80, in addition to the trajectory of the driver's eye over time, a vertical amplitude ΔY2, a horizontal amplitude ΔX2, and a duration of horizontal reciprocating movement ΔT2 of the trajectory are acquired.

In step S90, the trajectory of the driver's eye, the vertical amplitude ΔY1, the horizontal amplitude ΔX1, and the duration of vertical reciprocating movement ΔT1 for the head nodding movement acquired in step S70 are stored in the memory 17 in association with the personnel authorized in step S10. The trajectory of the driver's eye, the vertical amplitude ΔY2, the horizontal amplitude ΔX2, and the duration of horizontal reciprocating movement ΔT2 for the head shaking movement acquired in step S80 are also stored in the memory 17 in association with the personnel authorized in step S10.

(2) Head Movement Detection

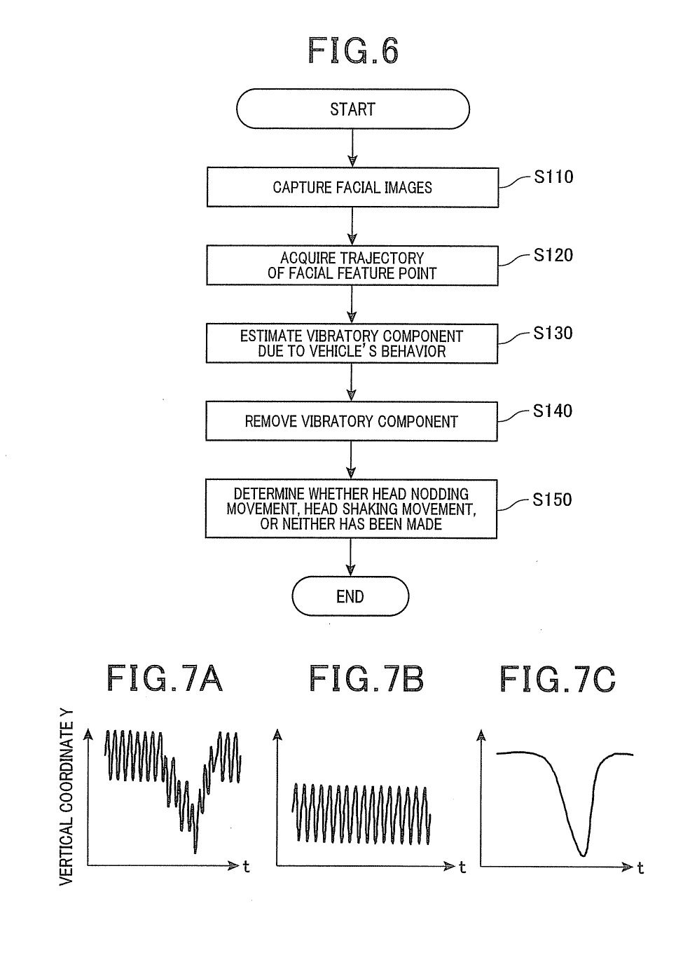

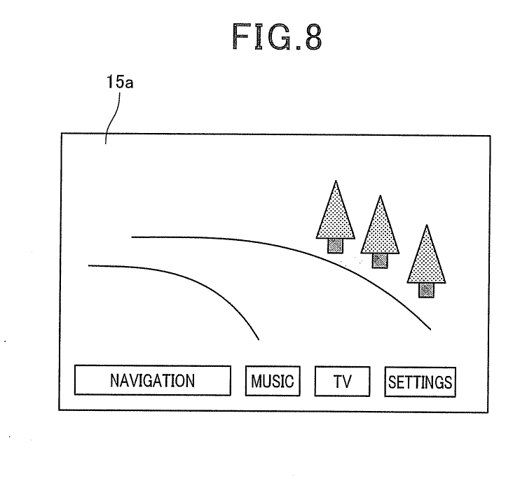

There will now be explained a head movement detection process performed in the head movement detection apparatus 1 with reference to FIGS. 6 to 8. FIG. 6 shows a flowchart for the head movement detection process. FIGS. 7A to 7C show how a vibratory component removal process (which will be explained later) is performed. FIG. 8 shows an exemplary display image. The head movement detection process is also performed under control of the central controller 31.

Referring to FIG. 6, in step S110, a facial image of the driver is captured repeatedly every third predetermined time interval by using the camera 3 over a third predetermined time period, as in step S40 or S60. The third predetermined time interval may be equal to the first or second predetermined time interval or may be different therefrom. The third predetermined time period may be equal to the first or second predetermined time period or may be different therefrom.

In step S120, a trajectory of the driver's eye over the third predetermined time period, which is a path connecting a sequence of locations of the driver's eye appearing in the respective facial images captured in step S110, is acquired.

In step S130, a vibratory component due to a vehicle's behavior during the third predetermined time is estimated, for example, by using detected values of the accelerometer 25 and the seat pressure sensor 29. Alternatively, the vibratory component may be estimated by using a blur width and a velocity of the driver's eye detected when no head movement is made by the driver.

In step S140, the vibratory component estimated in step S130 is subtracted from the trajectory acquired in step S120. In general, the trajectory acquired in step S120 as shown in FIG. 7A includes a component due to a driver's head movement only as shown in FIG. 7C and a vibratory component due to a vehicle's behavior (which is noise) as shown in FIG. 7B. Therefore, the component due to the driver's head movement (hereinafter also referred to as a noise-free trajectory) can be obtained by subtracting the vibratory component due to the vehicle's behavior from the trajectory acquired in step S120.

In step S150, on the basis of the noise-free trajectory acquired in step S140, it is determined whether the head nodding movement, the head shaking movement, or neither has been made by the driver.

To this end, first, the driver's personal database is read from the memory 17. As described above, the personal database includes the vertical amplitude ΔY1, the horizontal amplitude ΔX1, and the duration of vertical reciprocating movement ΔT1 of the trajectory of the driver's eye during the head nodding movement. The personal database further includes the vertical amplitude ΔY2, the horizontal amplitude ΔX2, and the duration of horizontal reciprocating movement ΔT2 of the trajectory of the driver's eye during the head shaking movement.

Thresholds TY1, TX1, TT1, TY2, TX2, and TT2, on the basis of which it is determined whether the head nodding movement, the head shaking movement, or neither has been made, are calculated as follows by using the vertical amplitude ΔY1, the horizontal amplitude ΔX1, the duration of vertical reciprocating movement ΔT1, the vertical amplitude ΔY2, the horizontal amplitude ΔX2, and the duration of horizontal reciprocating movement ΔT2, stored in the memory 17.

TY1=(ΔY1)×α,

TX1=(ΔX1)×β,

TT1=(ΔT1)×γ,

TY2=(ΔY2)×β,

TX2=(ΔX2)×α,

TT2=(ΔT2)×γ,

where α(alpha)=0.5, β(beta)=2, and γ(gamma)=1.5.

Subsequently, a vertical amplitude ΔY, a horizontal amplitude ΔX, and a duration of reciprocating movement ΔT (i.e., a set of features of the noise free trajectory) are calculated from the noise-free trajectory acquired in step S140, i.e., the component due to the driver's head movement obtained by subtracting the vibratory component due to the vehicle's behavior from the trajectory acquired in step S120.

If the following inequalities (1) to (3) are all fulfilled, that is, if the vertical amplitude ΔY, the horizontal amplitude ΔX, and the duration of reciprocating movement ΔT of the noise-free trajectory acquired in step S140 are within a first range of trajectory features defined by the inequalities (1) to (3) which is a three-dimensional range (which means there exists a higher degree of correspondence between the set of features of the trajectory of the driver's eye during the head nodding movement that are previously stored in the first memory 17 and the set of features of the noise-free trajectory), then it is determined that the head nodding movement has been made by the driver. If the following inequalities (4) to (6) are all fulfilled, that is, if the vertical amplitude ΔY, the horizontal amplitude ΔX, and the duration of reciprocating movement ΔT of the noise-free trajectory acquired in step S140 are within a second range of trajectory features defined by the inequalities (4) to (6) which is also a three-dimensional range (which means there exists a higher degree of correspondence between the set of features of the trajectory of the driver's eye during the head shaking movement that are previously stored in the first memory 17 and the set of features of the noise-free trajectory), then it is determined that the head shaking movement has been made by the driver. If none of the above, then it is determined that neither the head nodding movement nor the head shaking movement has been made by the driver.

ΔY>TY1 (1)

ΔX<TX1 (2)

ΔT<TT1 (3)

ΔY<TY2 (4)

ΔX>TX2 (5)

ΔT<TT2 (6)

If it is determined in step S150 that the head nodding movement has been made by the driver, then the item that has already been selected by the cursor or the like on the display 15a of the navigation system 36 will be performed. For example, as shown in FIG. 8, the item “NAVIGATION” has already been selected by the cursor and this item will be performed. If it is determined in step S150 that the head shaking movement has been made by the driver, then the cursor or the like will move from one item to the next item on the display 15a of the navigation system 36 and the next item will be selected. For example, as shown in FIG. 8, the cursor will move from the item “NAVIGATION” to the item “MUSIC” and the item “MUSIC” will be selected. If it is determined in step S150 that neither the head nodding movement nor the head shaking movement has been made by the driver, then nothing will occur.

3. Some Benefits

(i) In the head movement detection apparatus 1, the thresholds TY1, TX1, TT1, TY2, TX2, TT2, on the basis of which it is determined whether the head nodding movement, the head shaking movement, or neither has been made by the driver, are calculated from the actual trajectory of the driver's eye over time. Therefore, even though the head movement may change from person to person, it can be determined reliably whether the head nodding movement, the head nodding movement or neither has been made by the driver.

(ii) In the head movement detection apparatus 1, it is determined whether the head nodding movement, the head shading movement, or neither has been made by the driver, on the basis of the noise-free trajectory, that is, the component due to the head movement that is obtained by subtracting the vibratory component due to the vehicle's behavior from the trajectory of the driver's eye over time. This leads to a more reliable determination of whether the head nodding movement, the head nodding movement, or neither has been made by the driver.

4. Some Modifications

There will now be explained some modifications of the above described embodiment that may be devised without departing from the spirit and scope of the present invention.

In the head movement detection apparatus 1 of the above embodiment, the trajectory of the driver's eye over time is acquired to determine a head movement of the driver. Alternatively, a trajectory of another facial feature point (for example, a nose, a mouth, a left or right ear or the like) over time may be acquired to determine a head movement of the driver.

In the head movement detection apparatus 1 of the above embodiment, it is determined whether the head nodding movement, the head shading movement, or neither has been made by the driver. Alternatively, it may be determined only whether or not the head nodding movement has been made by the driver, or it may be determined only whether or not the head shaking movement has been made by the driver.

In addition, in the head movement detection apparatus 1 of the above embodiment, the navigation system 36 is controlled in response to a determination of whether the head nodding movement, the head nodding movement, or neither has been made by the driver. Alternatively, a device or devices other than the navigation system 36 may be controlled in response to a determination of whether the head nodding movement, the head nodding movement, or neither has been made by the driver.

In the head movement detection apparatus 1 of the above embodiment, the coefficient α used to calculate the thresholds TY1 and TX2 is 0.5, the coefficient β used to calculate the thresholds TX1 and TY2 is 2, and the coefficient γ used to calculate the thresholds TT1 and 1T2 is 1.5. Alternatively, the coefficients α, β, and γ may be set to a value other than 0.5, a value other than 2, and a value other than 1.5, respectively.

In the head movement detection apparatus 1 of the above embodiment, the personal database includes the vertical amplitude ΔY1, the horizontal amplitude ΔX1, and the duration of vertical reciprocating movement ΔT1 of the trajectory of the driver's eye during the head nodding movement. The personal database further includes the vertical amplitude ΔY2, the horizontal amplitude ΔX2, and the duration of horizontal reciprocating movement ΔT2 of the trajectory of the driver's eye during the head shaking movement. Alternatively, the personal database may include the trajectory of the driver's eye during the head nodding movement and the trajectory of the driver's eye during the head shaking movement. In such an alternative embodiment, it may be determined whether the head nodding movement, the head shaking movement, or neither has been made by the driver, by comparing the trajectory acquired in step S140 with each of the trajectory for the head nodding movement and the trajectory for the head shaking movement of each user previously stored in the personal database.

In the head movement detection apparatus 1 of the above embodiment, the head movement detector 11, as described above with reference to FIG. 1B, includes the trajectory acquisition unit 111, the vibratory component estimation unit 113, the vibratory component removal unit 115, the head movement detection unit 117, and the setting unit 119. Alternatively, for example, when the vibratory component due to the vehicle's behavior can be ignored or may not prevent the head movement detection unit 117 from detecting the specific head movement (such as a head nodding or shaking movement) made by the driver, the vibratory component removal unit 115 may be removed. In such an embodiment, as shown in FIG. 1C, the head movement detector 11 may only include the trajectory acquisition unit 111, the head movement detection unit 117, and the setting unit (as setting means) 119.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A head movement detection apparatus comprising:
an image capture unit that captures a facial image of a subject;
a trajectory acquisition unit that acquires a trajectory of a facial feature point of the subject over time from a sequence of facial images captured by the image capture unit;
a storage unit that stores a set of features of a trajectory of the facial feature point of the subject during a specific head movement made by the subject, the trajectory being acquired by the trajectory acquisition unit from a sequence of facial images captured by the image capture unit during the specific head movement made by the subject; and
a head movement detection unit that detects the specific head movement made by the subject on the basis of a degree of correspondence between the set of features of the trajectory previously stored in the storage unit and a corresponding set of features of a trajectory acquired by the trajectory acquisition unit.

2. The apparatus of claim 1, further comprising
a setting unit that defines a range of trajectory features specific to the subject for detecting the specific head movement made by the subject as a function of the set of features of the trajectory of the facial feature point of the subject previously stored in the storage unit,
wherein the head movement detection unit determines whether or not a corresponding set of features of a trajectory of the facial feature point of the subject acquired by the trajectory acquisition unit are within the range of trajectory features defined by the setting unit, and when it is determined that the corresponding set of features of the trajectory are within the range of trajectory features defined by the setting unit, then determines that the specific head movement has been made by the subject.

3. The apparatus of claim 1, wherein the facial feature point of the subject is selected from a group consisting of a left eye, a right eye, a left ear, a right ear, a nose, and a mouth of the face of the subject.

4. The apparatus of claim 1, wherein the specific head movement is a reciprocating head movement, and
the set of features of the trajectory of the facial feature point of the subject during the reciprocating head movement made by the subject are at least one of a vertical amplitude, a horizontal amplitude, and a duration of reciprocating movement of the trajectory.

5. The apparatus of claim 4, wherein the specific head movement is a head nodding movement, and
the set of features of the trajectory of the facial feature point during the head nodding movement made by the subject are the vertical amplitude, the horizontal amplitude, and the duration of vertical reciprocating movement of the trajectory.

6. The apparatus of claim 4, wherein the specific head movement is a head shaking movement, and
the set of features of the trajectory of the facial feature point during the head shaking movement made by the subject are the vertical amplitude, the horizontal amplitude, and the duration of horizontal reciprocating movement of the trajectory.

7. The apparatus of claim 1, wherein the apparatus is mounted in a vehicle, the subject is a driver of the vehicle, and the apparatus further comprises:
a vibratory component estimation unit that estimates a vibratory component due to a vehicle's behavior included in a trajectory of the facial feature point of the driver acquired by the trajectory acquisition unit; and
a vibratory component removal unit that subtracts the vibratory component estimated by the vibratory component estimation unit from the trajectory of the facial feature point of the driver acquired by the trajectory acquisition unit to acquire a noise-free trajectory of the facial feature point of the driver,
the head movement detection unit detects the specific head movement made by the driver on the basis of a degree of correspondence between the set of features of the trajectory previously stored in the storage unit and a corresponding set of features of the noise-free trajectory of the facial feature point of the driver acquired by the vibratory component removal unit.

8. The apparatus of claim 1, wherein
the storage unit stores, for each of a plurality of subjects, the set of features of the trajectory of the facial feature point of the subject during the specific head movement made by the subject; and
the head movement detection unit identifies which one of the plurality of subjects, and detects, for each of the plurality of subjects, the specific head movement made by the subject on the basis of a degree of correspondence between the set of features of the trajectory of the facial feature point during the specific head movement made by the same subject that are previously stored in the storage unit and a corresponding set of features of a trajectory of the facial feature point of the subject acquired by the trajectory acquisition unit.

9. The apparatus of claim 1, wherein the specific head movement is a first specific head movement,
the storage unit stores a set of features of a first trajectory of the facial feature point of the subject during the first specific head movement made by the subject and a set of features of a second trajectory of the facial feature point of the subject during a second specific head movement made by the subject, and
the head movement detection unit determines whether the first head movement, the second head movement or neither has been made by the subject on the basis of a degree of correspondence between the set of features of the first trajectory previously stored in the storage unit and a corresponding set of features of a trajectory acquired by the trajectory acquisition unit and a degree of correspondence between the set of features of the second trajectory previously stored in the storage unit and the corresponding set of features of the trajectory acquired by the trajectory acquisition unit.

10. The apparatus of claim 9, wherein the first specific head movement is a head nodding movement, and the second specific head movement is a head shaking movement.

11. The apparatus of claim 1, further comprising a feature point detector that detects the facial feature point of the subject in each facial image captured by the image capture unit.

12. A head movement detection apparatus comprising:
an image capture unit that captures a facial image of a subject;
a trajectory acquisition unit that acquires a trajectory of a facial feature point of the subject over time from a sequence of facial images captured by the image capture unit;
a storage unit that stores a trajectory of the facial feature point of the subject during a specific head movement made by the subject, the trajectory being acquired by the trajectory acquisition unit from a sequence of facial images captured by the image capture unit during the specific head movement made by the subject; and
a head movement detection unit that detects the specific head movement made by the subject on the basis of a degree of correspondence between the trajectory previously stored in the storage unit and a trajectory acquired by the trajectory acquisition unit.

13. The apparatus of claim 12, wherein the facial feature point of the subject is selected from a group consisting of a left eye, a right eye, a left ear, a right ear, a nose, and a mouth of the face of the subject.

14. The apparatus of claim 12, wherein the apparatus is mounted in a vehicle, the subject is a driver of the vehicle, and the apparatus further comprises:
a vibratory component estimation unit that estimates a vibratory component due to a vehicle's behavior included in a trajectory of the facial feature point of the driver acquired by the trajectory acquisition unit; and
a vibratory component removal unit that subtracts the vibratory component estimated by the vibratory component estimation unit from the trajectory of the facial feature point of the driver acquired by the trajectory acquisition unit to acquire a noise-free trajectory of the facial feature point of the driver,
the head movement detection unit detects the specific head movement made by the driver on the basis of a degree of correspondence between the trajectory previously stored in the storage unit and the noise-free trajectory of the facial feature point of the driver acquired by the vibratory component removal unit.

15. The apparatus of claim 12, wherein
the storage unit stores, for each of a plurality of subjects, the trajectory of the facial feature point of the subject during the specific head movement made by the subject; and
the head movement detection unit identifies which one of the plurality of subjects, and detects, for each of the plurality of subjects, the specific head movement made by the subject on the basis of a degree of correspondence between the trajectory of the facial feature point during the specific head movement made by the same subject that is previously stored in the storage unit and a trajectory of the facial feature point of the subject acquired by the trajectory acquisition unit.

16. The apparatus of claim 12, wherein the specific head movement is a first specific head movement,
the storage unit stores a first trajectory of the facial feature point of the subject during the first specific head movement made by the subject and a second trajectory of the facial feature point of the subject during a second specific head movement made by the subject, and
the head movement detection unit determines whether the first head movement, the second head movement or neither has been made by the subject on the basis of a degree of correspondence between the first trajectory previously stored in the storage unit and a trajectory acquired by the trajectory acquisition unit and a degree of correspondence between the second trajectory previously stored in the storage unit and the trajectory acquired by the trajectory acquisition unit.

17. The apparatus of claim 16, wherein the first specific head movement is a head nodding movement, and the second specific head movement is a head shaking movement.

18. The apparatus of claim 12, further comprising a feature point detector that detects the facial feature point of the subject in each facial image captured by the image capture unit.
